(19) United States
(12) Patent Application Publication
(10) Pub. No.: US 2011/0140484 A1
(43) Pub. Date: Jun. 16, 2011

(54) Multi-Function Chair

(76) Inventor: CHIN AN CHANG, Yangmei Township (TW)

(21) Appl. No.: 12/636,350

(22) Filed: Dec. 11, 2009

(51) Int. Cl. A47C 13/00; A61H 7/00; A63B 21/04

(52) U.S. Cl. 297/118; 601/134; 482/130

(57) ABSTRACT

A multi-function includes a treadmill, elastic pull ropes for exercise and a massage device which is manually controlled. The treadmill is disposed under a chair seat. When in use, the treadmill is pulled out. When not in use, the treadmill is retracted under the chair. The elastic pull ropes are disposed at two sides of a back pad of the chair to be pulled up and down for the user to do hand exercises. The massage device is disposed behind the back pad of the chair. The massage device has a massage assembly which can be inclined forward to massage the user's head, neck and shoulder. When not in use, the massage assembly is inclined rearward.

### BACKGROUND OF THE INVENTION

1. Field of the Invention

The present invention relates to a chair, in particular to a multi-function chair having an exercising device and a massage device for an office desk or a computer desk, such that the user can do hand and foot exercises and massage his/her head, neck and shoulder after sitting for a long time.

2. Description of the Prior Art

A conventional chair only provides a seat function, without an exercising device and a massage device. Accordingly, the inventor of the present invention has devoted himself based on his many years of practical experiences to solve this problem.

### SUMMARY OF THE INVENTION

The primary object of the present invention is to provide a multi-function chair for an office desk or a computer desk. The chair is provided with exercising devices and a massage device. The exercising devices are disposed under a chair seat and at two sides of a back pad of the chair, respectively. The massage device is disposed behind the back pad of the chair.

The multi-function chair of the present is different from the conventional office chair or computer chair, which provides the user to do hand and foot exercises and massage his/her head, neck and shoulder.

According to the present invention, there is provided a multi-function chair with an exercising device and a massage device which is manually controlled, comprising:

a treadmill disposed under a chair seat;

two pairs of elastic pull ropes disposed at two sides of a back pad of the chair; and

the massage device having a massage assembly disposed above the back pad of the chair and a pair of control assemblies disposed at two sides of the chair seat.

Preferably, the treadmill is mounted on a holder, two sides of the holder being provided with tracks connected to a chair base for the treadmill to be retracted in or extended out.

Preferably, the two pairs of elastic pull ropes have different elastic forces, under the elastic pull ropes being provided with adjustment holes for adjusting the elastic forces of the elastic pull ropes.

Preferably, the massage device has massage members each having a spring at an upper end thereof, the massage assembly being adjustable to incline forward for getting in touch with the head, the neck, the shoulder of a human body, the massage assembly being connected with the control assembly via a steel cable for controlling a handle member to act the massage assembly.

### BRIEF DESCRIPTION OF THE DRAWINGS

FIG. 1 is a perspective view according to a preferred embodiment of the present invention;

FIG. 2 is a perspective view showing a treadmill when in use according to the preferred embodiment of the present invention;

FIG. 3 is a perspective view showing elastic pull ropes when in use according to the preferred embodiment of the present invention;

FIG. 4 is a schematic view showing interaction of a massage assembly and a control assembly according to the preferred embodiment of the present invention;

FIG. 5 is a schematic view showing the massage assembly inclined forward according to the preferred embodiment of the present invention;

FIG. 6 is a schematic view showing the massage assembly inclined rearward according to the preferred embodiment of the present invention; and

FIG. 7 is a schematic view showing another interaction of the massage assembly and the control assembly according to the preferred embodiment of the present invention.

### DETAILED DESCRIPTION OF THE PREFERRED EMBODIMENTS

Embodiments of the present invention will now be described, by way of example only, with reference to the accompanying drawings.

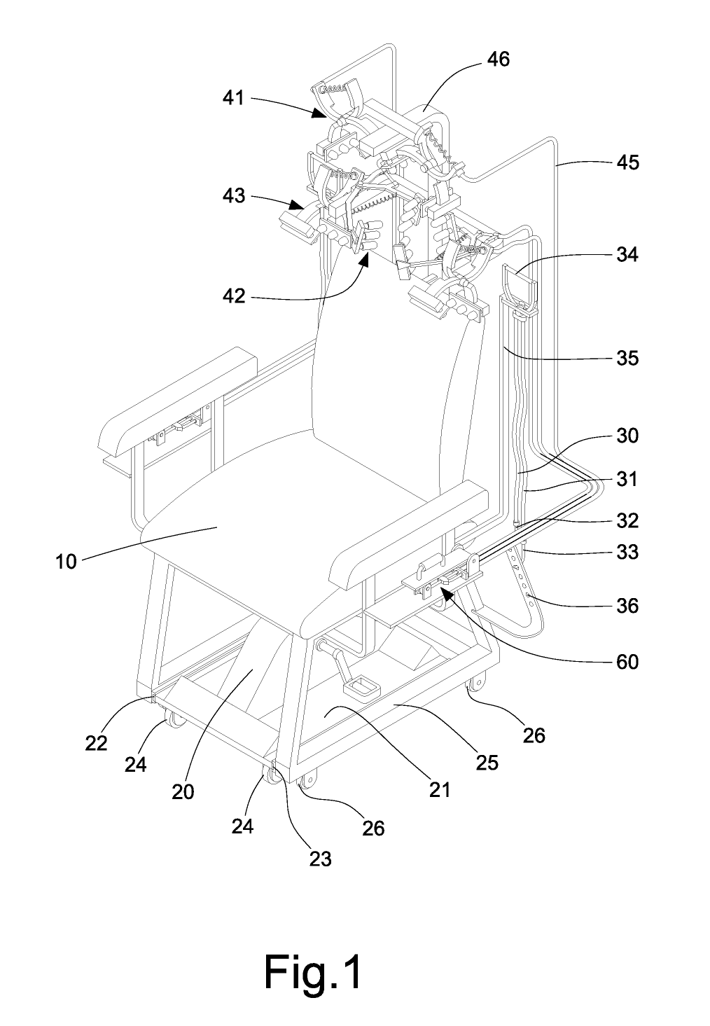

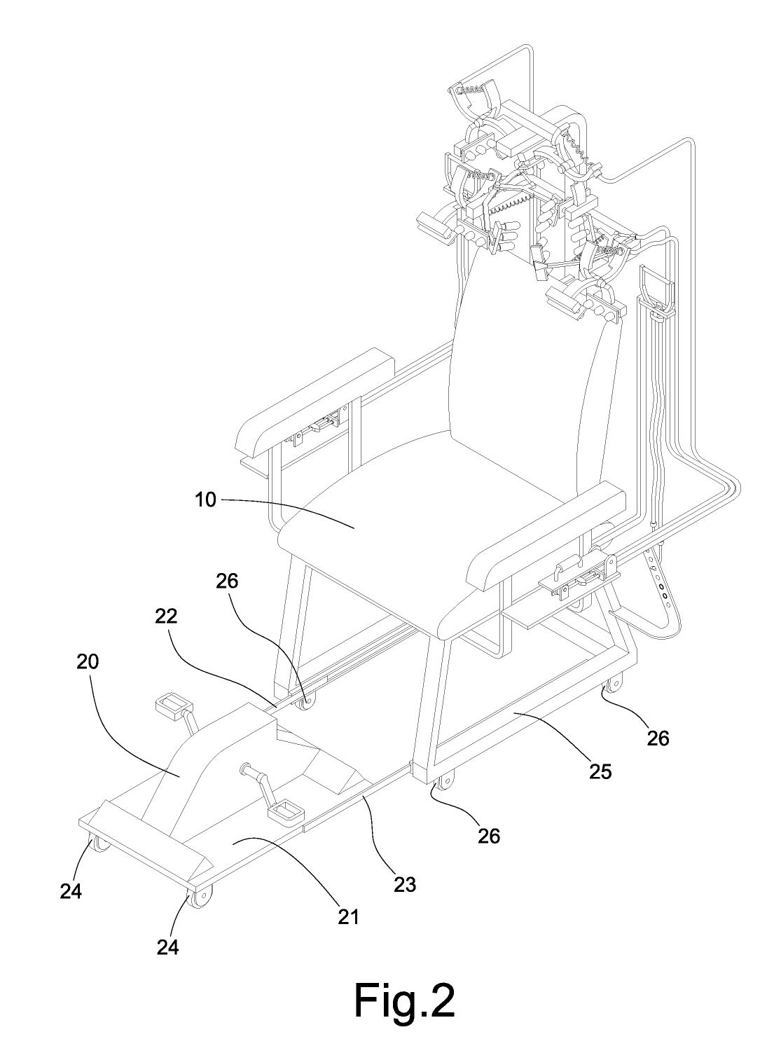

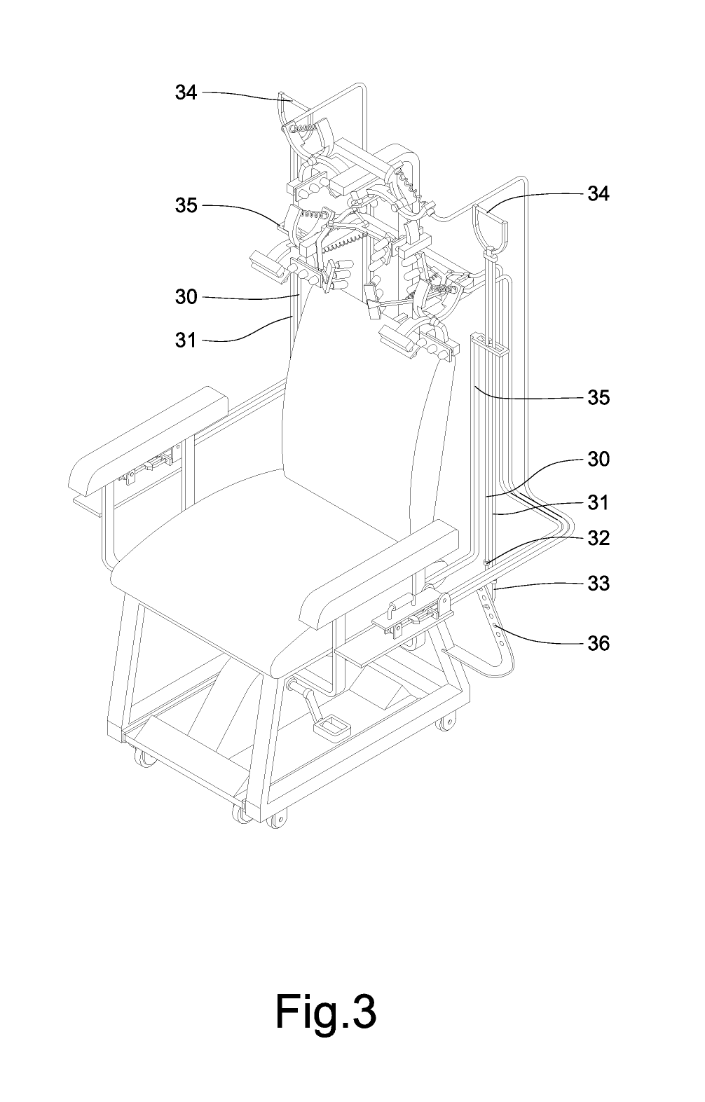

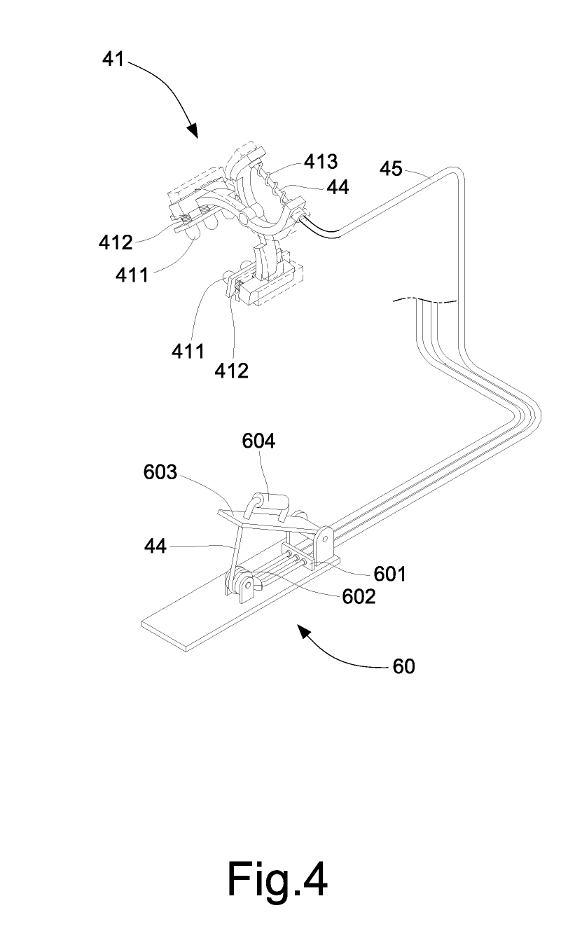

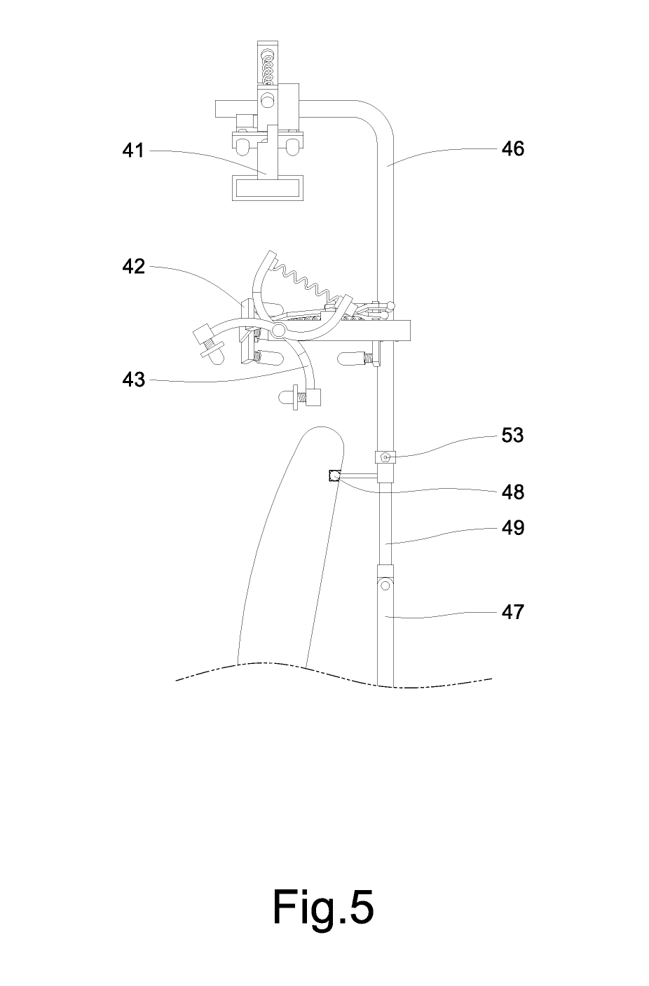

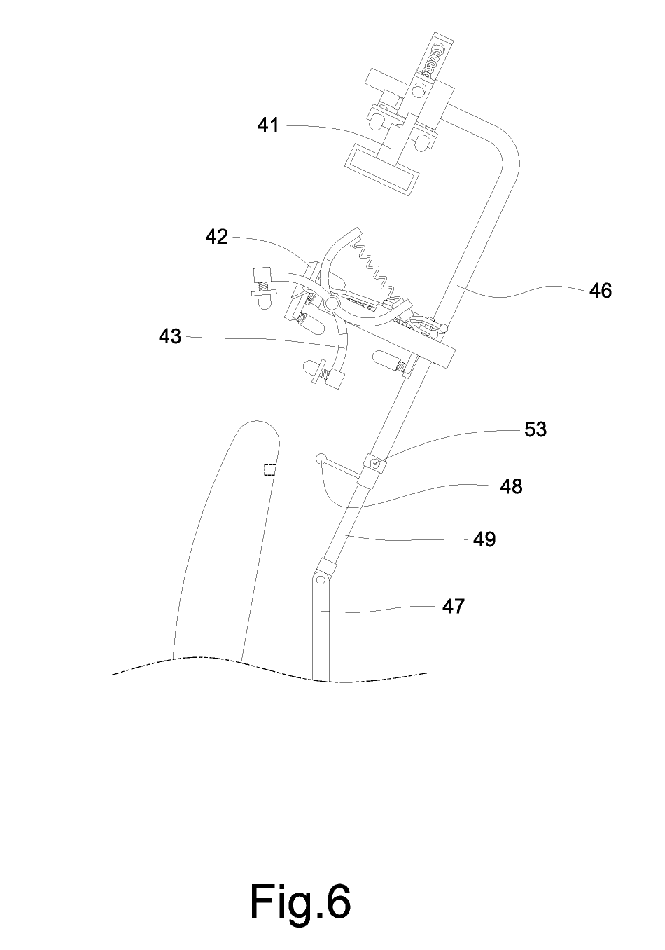

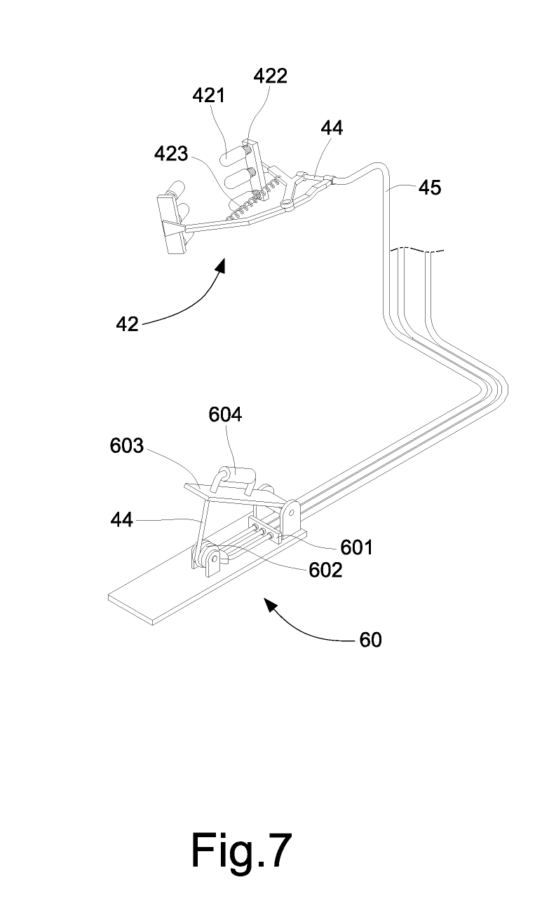

As shown in FIG. 1 to FIG. 7, a multi-function chair with an exercising device and a massage device according to a preferred embodiment of the present invention comprises a chair body 10 and a treadmill 20 disposed under the chair body 10. The treadmill 20 is mounted on a holder 21. The holder 21 includes a left track 22, a right track 23 and a pair of casters 24 at two sides thereof. The left track 22 and the right track 23 are connected to two sides of a chair base 25. Four casters 26 are provided under the chair base 25. When not in use, the treadmill 20 is retracted under the chair body 10. When in use, the holder 21 is pulled out with the user's foot.

The chair of the present invention includes two pairs of elastic pull ropes 30, 31 which are disposed at two sides of a back pad of the chair. A handle 34 is provided at upper ends of the elastic pull ropes 30, 31. The handle 34 is supported by a retaining bracket 35. The pull ropes 30, 31 have different elastic forces. The pull ropes 30, 31 have lower ends provided with hooks 32, 33, respectively. The hooks 32, 33 are respectively engaged with adjustment holes 36 for adjusting a desired elastic force. When in use, the handle 34 is pulled up and down.

The chair of the present invention includes a massage device which is manually controlled and comprises a massage assembly and a control assembly 60. The massage assembly comprises a head massage unit 41, a neck massage unit 42, and a shoulder massage unit 43. The massage assembly is connected with a handle member via a steel cable 44 and a steel cable pipe 45, such that the massage assembly is driven by the handle member to act. The massage assembly includes a main rod 46, a connection rod 47 connected to a lower end of the main rod 46, and a buckle member 48 at a middle portion thereof for securing the main rod 46 when the main rod 46 is leaned forward or rearward. The main rod 46 includes an inner rod 49 therein. A fastening bolt 53 is provided on the main rod 46. The height of the main rod 46 is adjustable along the inner rod 49, and the main rod 46 can be positioned by the fastening bolt 53. The massage unit comprises four to six massage members 411, 421 which are made of solid silicon and have springs 412, 422 thereon for adjusting the pressure of the massage members 411, 421. The massage unit acts as a pair of scissors, having one end provided with the massage members 411, 421 and another end connected with the steel cable 44 and the steel cable pipe 45. Return springs 413, 423 are provided at the applied force end. When the applied force end is applied with force, the massage members 411, 421 will act to provide a massage effect. When the applied force end is released, the return springs 413, 423 will return the massage members 411, 421 to their original positions.

The control assembly 60 is disposed next to a seat of the chair. The control assembly 60 comprises a stop box 601, a pulley 602, a board 603, and a handle member 604. The massage assembly is connected with the control assembly via the steel cable 44 and the steel cable pipe 45. The stop box 601 is adapted to secure the steel cable pipe 45. The steel cable 44 extends through the stop box 601 and the pulley 602 to be secured to the board 603. When the handle member 604 on the board 603 is pulled up, the steel cable 44 will be driven to act the massage members for providing a head, neck, and should massage effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A multi-function chair with an exercising device and a massage device which is manually controlled, comprising:
a treadmill disposed under a chair seat;
two pairs of elastic pull ropes disposed at two sides of a back pad of the chair; and
the massage device having a massage assembly disposed above the back pad of the chair and a pair of control assemblies disposed at two sides of the chair seat.

2. The multi-function chair as claimed in claim 1, wherein the treadmill is mounted on a holder, two sides of the holder being provided with tracks connected to a chair base for the treadmill to be retracted in or extended out.

3. The multi-function chair as claimed in claim 1, wherein the two pairs of elastic pull ropes have different elastic forces, under the elastic pull ropes being provided with adjustment holes for adjusting the elastic forces of the elastic pull ropes.

4. The multi-function chair as claimed in claim 1, wherein the massage device has massage members each having a spring at an upper end thereof, the massage assembly being adjustable to incline forward for getting in touch with the head, the neck, the shoulder of a human body, the massage assembly being connected with the control assembly via a steel cable for controlling a handle member to act the massage assembly.
